(19) United States
(12) Patent Application Publication
(10) Pub. No.: US 2019/0179001 A1
(43) Pub. Date: Jun. 13, 2019

(54) RADAR DEVICE FOR OBJECT IDENTIFICATION

(71) Applicant: VEGA Grieshaber KG, Wolfach (DE)

(72) Inventor: Robert Laun, Hausach (DE)

(73) Assignee: VEGA Grieshaber KG, Wolfach (DE)

(21) Appl. No.: 16/208,203

(22) Filed: Dec. 3, 2018

(30) Foreign Application Priority Data
Dec. 8, 2017 (DE) 10 2017 222 272.7

(51) Int. Cl. G01S 13/34; G01S 13/88; G01S 7/41

(52) U.S. Cl. CPC G01S 13/341; G01S 7/411; G01S 13/881; G01S 13/347

(57) ABSTRACT

A radar device for identifying an object is provided, the radar device including at least one antenna configured to transmit a transmission signal and to receive a reflected signal; an evaluation circuit configured to determine a receiving signal based on the reflected signal; and a control unit configured to evaluate the receiving signal in a frequency portion of the receiving signal, and to determine whether a specified frequency that corresponds to a specific distance of the object from the radar device is contained in the frequency portion of the receiving signal.

### CROSS-REFERENCE TO RELATED APPLICATIONS

This application claims the benefit of the filing date of German Patent Application No. 10 2017 222 272.7, filed on 8 Dec. 2017, the entire content of which is incorporated herein by reference.

### FIELD OF THE DISCLOSURE

The disclosure generally relates to the field of object identification and/or limit level monitoring. The disclosure relates in particular to a radar device, such as a limit level radar device, for identifying an object and/or a limit level of a medium. The disclosure further relates to a method for identifying an object, using a radar device, a computer program element and a computer-readable medium.

### BACKGROUND OF THE DISCLOSURE

Radar devices, such as Frequency Modulated Continuous Wave (FMCW) radar sensors, are frequently used for determining a fill level and/or limit level of a medium in a container. Radar devices can also be used for detecting an object and/or a limit level of a medium, it being possible for an echo at a specific location and/or in a specific region to be associated with the object and/or the limit level. If said echo is present, the object can be marked as present and/or the limit level can be marked as reached. In contrast, if said echo is not detected, the object can be marked as not present and/or the limit level can be marked as not reached. In order to detect the echo associated with the object and/or the limit level, existing radar devices or radar sensors calculate a complete echo curve by means of a Fourier transform, in particular by means of fast Fourier transform (FFT), which may be associated with high computational outlay and time expenditure. This may also require high processing power and therefore expensive signal processors and/or microcontrollers. Object identification is also often carried out using a continuous radar, it being possible in this case for all reflecting objects to generate a detection signal at different positions in the measuring range of the continuous radar, with the result that it is not possible to associate a detection signal with the presence of a specific object at a specific position. If a transceiver pair is used, for example in the case of a reflection microwave barrier, two devices are in addition required.

### SUMMARY

An improved radar device for object identification and/or limit level monitoring can advantageously be provided by means of embodiments of the present disclosure.

An aspect of the disclosure relates to a radar device and/or a radar sensor for identifying an object. The radar device comprises at least one antenna for transmitting a transmission signal and for receiving a reflected signal, in particular a signal reflected on the object. The radar device further comprises an evaluation circuit that is configured to determine a receiving signal on the basis of the reflected signal. The radar device further comprises a control unit that is configured for evaluating the receiving signal in a frequency portion of the receiving signal, the control unit being configured to determine whether a specified frequency that corresponds to and/or is associated with a specific and/or specified distance of an object from the radar device is contained in the frequency portion of the receiving signal. In this case, the specified frequency may be associated with a reflection of the transmission signal on the object at a specific distance and/or may be caused by said reflection, with the result that, when the specified frequency is present, the radar device can determine whether or not the object is present.

The radar device can in general denote a radar sensor for object identification. In particular, the radar device may be a fill level measurement device for determining a fill level of a medium. Alternatively or in addition, the radar device may be a limit level radar device and/or a limit level sensor that is configured for determining a limit level of a medium, for example in a container. The radar device may be configured as an FMCW radar device. Likewise, the receiving signal may be an FMCW receiving signal. Alternatively or in addition, the radar device may be configured as a Stepped Frequency Continuous Wave (SFCW) radar.

Furthermore, the radar device may be configured as a limit level radar device for limit level monitoring of a medium, for example in a container, and/or for limit level monitoring of a channel. In other words, the object may be a limit level of a medium.

The object may also be a container, and/or the radar device may be configured to detect and/or determine the presence of the container. In general, the object may be any desired object that reflects the transmission signal, for example an object and/or product on a conveyor belt. The radar device may also determine a position of a boom, for example.

The radar device according to the disclosure may in particular be configured for examining the receiving signal for the presence of the specified frequency merely and/or exclusively in the frequency portion of the measuring signal. In this case, the frequency portion may be small relative to an overall frequency spectrum of the receiving signal. For example, the frequency portion may be at most 75% of the frequency spectrum, in particular at most 50% of the frequency spectrum, and preferably between 1% and 25% of the frequency spectrum of the receiving signal. Evaluating the receiving signal in the frequency portion means that it is not necessary to evaluate the entire receiving signal by frequency and/or it is not necessary to determine a complete echo curve, but rather the receiving signal can be analysed only at the location and/or only in the frequency portion in which an echo is anticipated, owing to reflection of the transmission signal on the object. The radar device can essentially analyse whether or not the specified frequency is present in the receiving signal. Compared with complete evaluation of the receiving signal or determination of a complete echo curve, computational outlay and/or time expenditure can thus be saved. The radar device according to the disclosure can thus quickly and efficiently determine the presence of the specified frequency and/or the presence of the object. It is also possible, as a result, to dispense with expensive signal processors, control units and/or microcontrollers, and therefore the radar device can be manufactured in a cost-effective manner overall.

The specified frequency may be stored in a memory of the radar device, for example, and may be set by a user of the radar device, for example. For example, the radar device may comprise a user interface for inputting user input relating to the distance of the object. The control unit may furthermore be configured to determine the specified frequency in the receiving signal, on the basis of the user input relating to the distance of the object. For this purpose, for example a conversion table for converting distances into frequencies may be stored in the memory of the radar device. Alternatively or in addition, the specified frequency can be input via the user interface.

According to an embodiment of the disclosure, the control unit is configured to evaluate the receiving signal in the frequency portion on the basis of a Fourier transform. Alternatively or in addition, the control unit is configured to determine a partial echo curve in the frequency portion of the receiving signal, which partial echo curve is associated with a specific, in particular a specified, distance range from the radar device. For example, for this purpose, a fast Fourier transform (FFT) and/or a discrete Fourier transform (DFT) may be applied to the receiving signal for the frequencies of the frequency portion.

According to an embodiment of the disclosure, the control unit is configured to evaluate the receiving signal, for the specified frequency, in the frequency portion on the basis of a Goertzel filter. Alternatively or in addition, the control unit is configured to determine the presence of the specified frequency in the receiving signal using a Goertzel filter. Using a Goertzel filter can make it possible to quickly, efficiently, and reliably check the receiving signal for the presence of the specified frequency and thus for the presence of the object.

According to an embodiment of the disclosure, the control unit is configured to dismiss and/or hide all frequencies of the receiving signal outside the frequency portion. The control unit can therefore be configured to evaluate and/or analyse the receiving signal exclusively in the frequency portion. Alternatively or in addition, the control unit may be configured to examine the receiving signal exclusively for the presence of a single specified frequency. As a result, it is not necessary to analyse the receiving signal over the entire frequency spectrum thereof, but instead the presence of the specified frequency can be determined efficiently and quickly.

According to an embodiment of the disclosure, the control unit is configured to evaluate the receiving signal in a plurality of frequency portions and to determine whether a specified frequency is contained in the respective frequency portions. In this case, it is possible for the individual frequency portions not to overlap and/or to be mutually separated. As a result, it is possible to quickly and efficiently determine the presence of a plurality of different objects at different distances from the radar device.

According to an embodiment of the disclosure, the control unit is configured to emit a control signal and/or switching signal if the specified frequency is contained in the receiving signal. Via the control signal a user can be informed, for example, of the presence of the object. For this purpose, the control signal can be used for example for actuating a signal light. It is also possible for an output to be provided for example on a user interface and/or on a display element, on the basis of the control signal, which output can indicate to the user the presence of the object.

A further aspect of the disclosure relates to the use of a Goertzel filter in a radar device for determining the presence of a specified frequency in a receiving signal of the radar device.

A further aspect of the disclosure relates to a method for identifying an object using a radar device. The method comprises the following steps:
transmitting a transmission signal and receiving a reflected signal by means of an antenna of the radar device;
generating, by means of an evaluation circuit of the radar device, a receiving signal, on the basis of the reflected signal; and
evaluating, by means of a control unit of the radar device, a frequency portion of the receiving signal while determining the presence, in the frequency portion, of a specified frequency that corresponds to a specific distance of an object from the radar device.

Features, elements and/or properties of the radar device, as described above and in the following, may be features, elements and/or steps of the method, as described above and in the following, and vice versa. In other words, any disclosure with respect to one aspect of the disclosure essentially applies for all other aspects of the disclosure.

A further aspect of the disclosure relates to a computer program element which, when executed on a control unit of a radar device, prompts the radar device to carry out the steps of the method, as described above and in the following.

A further aspect of the disclosure relates to a computer-readable medium and/or storage medium on which a computer program element is stored which, when executed on a control unit of a radar device, prompts the radar device to carry out the steps of the method, as described above and in the following.

### BRIEF DESCRIPTION OF THE FIGURES

Embodiments of the disclosure will be described in the following, with reference to the accompanying drawings. In this case, the same reference signs may denote identical, identically functioning or similar elements.

FIG. 1 shows a radar device according to an embodiment of the disclosure.

FIG. 2A shows a radar device according to an embodiment of the disclosure.

FIG. 2B shows an echo curve determined using the radar device 10 of FIG. 2A.

FIG. 3 is a flow diagram for illustrating steps of a method for identifying an object according to an embodiment of the disclosure.

The illustrations in the figures are merely schematic and are not to scale.

### DETAILED DESCRIPTION OF EMBODIMENTS

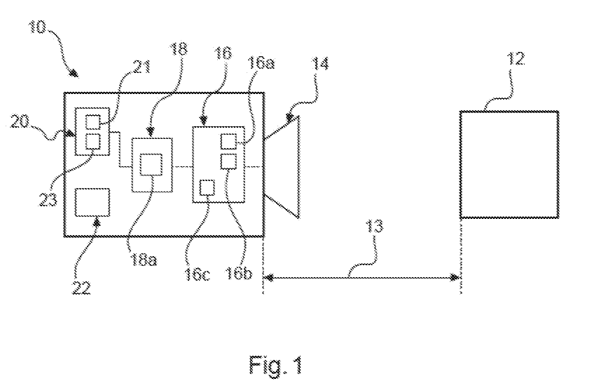

FIG. 1 shows a radar device 10 according to an embodiment of the disclosure. The radar device 10 is in particular configured for identifying an object 12, which is located at a distance 13 from the radar device 10 and/or is arranged at a spacing 13 from the radar device 10. In this case, the object 12 can in particular be a limit level of a medium, for example in a container, and/or a limit level of a channel. However, the object 12 can also be any other object.

The radar device 10 comprises an antenna 14 for transmitting and/or sending a transmission signal, a radar-based transmission signal, and/or a radar signal. The antenna 14 is furthermore configured for receiving a reflected signal and/or reflection signal. In order to generate the transmission signal, the radar device 10 may comprise a radar module for example.

The radar device 10 may in particular be configured as an FMCW radar 10. A frequency of the transmission signal can therefore be increased in a ramp-like manner, during a measurement cycle, from a starting frequency to an end frequency. In other words, the radar device 10 may be configured to pass through a frequency ramp when transmitting the transmission signal.

The radar device 10 further comprises an evaluation circuit 16 that is coupled to the antenna 14 and is configured to determine a receiving signal on the basis of the reflected signal. For this purpose, the evaluation circuit 16 may for example comprise a frequency mixer 16a that is configured to generate an intermediate-frequency signal on the basis of the transmission signal and/or the reflected signal. The evaluation circuit 16 may also comprise an intermediate-frequency amplifier 16b for amplifying the intermediate-frequency signal. The evaluation circuit 16 may also comprise a scanning unit 16c for scanning and/or digitising the intermediate-frequency signal and/or the amplified intermediate-frequency signal. The receiving signal can therefore generally denote a measuring signal that correlates with the intermediate-frequency signal and/or the reflected signal. For example, the receiving signal may denote the scanned intermediate-frequency signal and/or correlate thereto.

The radar device 10 further comprises a control unit 18 that is coupled to the evaluation circuit 16 and is configured to evaluate, analyse, and/or process the receiving signal and/or a portion of the receiving signal. The control unit 18 may, for example, denote and/or comprise a control circuit, a processor, a logic means, a data processing means, a signal processor, and/or a microcontroller.

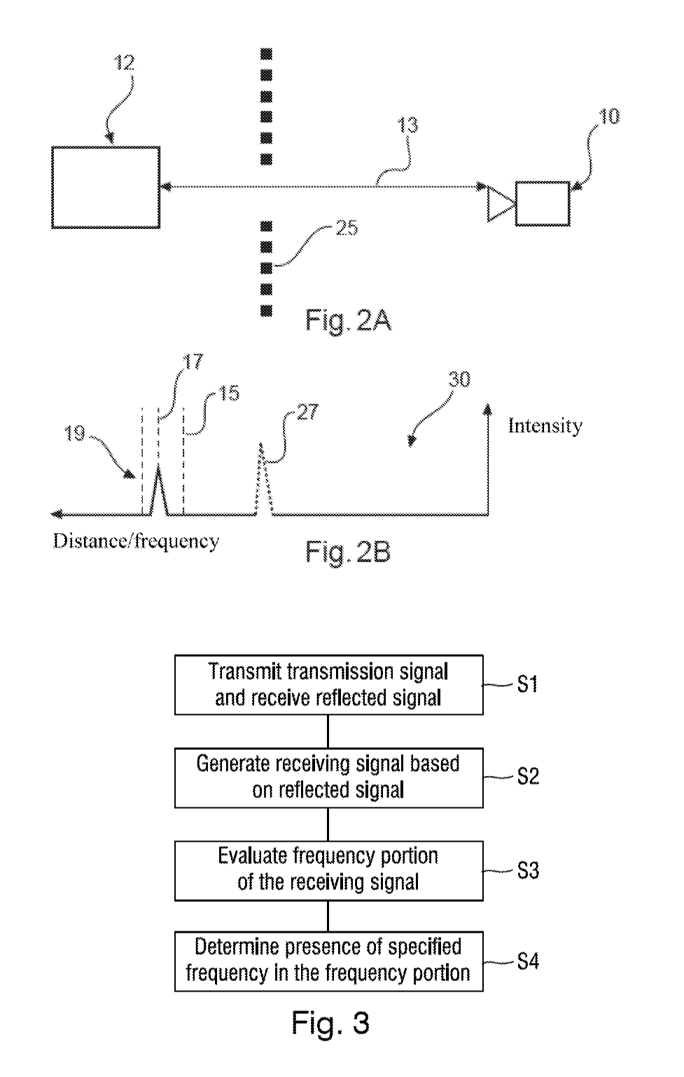

The control unit 18 is configured to determine whether a specified frequency 17 (see FIGS. 2A and 2B) that corresponds to and/or is associated with the distance 13 is contained in a frequency portion 15.

The radar device 10 may for example comprise a user interface 20 by means of which a user can perform a user input. In this case, the user interface may comprise any desired actuation element 21 and/or operating element 21 and/or a touchscreen display 21, for example. The user input may be and/or correlate with the distance 13 of the object 12, for example. Alternatively or in addition, the user can input the specified frequency 17 via the user interface 20. The specified frequency 17 can then be converted into the distance 13, for example, using a conversion table stored in a memory 23 of the radar device 10. The distance 13 itself and/or the specified frequency 17 may also be stored in the memory 23.

The control unit 18 is configured to evaluate the receiving signal on the basis of a Fourier transform. In order that the receiving signal can be quickly and efficiently examined for the presence of the specified frequency 17 in the frequency portion 15 of the receiving signal, the control unit 18 may comprise a Goertzel filter 18a and/or may evaluate the receiving signal using a Goertzel filter 18a. In this case, the Goertzel filter 18a may correspond to and/or be used for the calculation of a single frequency component 15, 17, for example a FFT. This can be calculated more quickly than an entire echo curve, only a reflection on the object 12 at the distance 13 being evaluated. All other reflections and/or frequencies outside the frequency portion 15 can be hidden. The control unit 18 can therefore carry out a Fourier transform only in the frequency portion 15, selectively and/or for the specified frequency 17. Essentially, the control unit 18 can be configured to determine only a partial echo curve 19 (see FIGS. 2A and 2B), on the basis of the receiving signal. In this case, the partial echo curve 19 may take place in the spatial region that corresponds to the frequency portion 15 and in which the object 12 is to be expected. In other words, the control unit 18 can analyse the receiving signal only at the location or region in which an echo and/or a reflection from the object 12 is expected, on the basis of the test as to whether or not the specified frequency 17 is present in the receiving signal. The radar device 10 can thus carry out the object identification efficiently and quickly.

In general, however, the radar device 10 may also be configured for determining a specified frequency 17 in each case in a plurality of frequency portions 15, in order to thus determine the presence of a plurality of different objects 12 at different distances 13. For this purpose, the radar device 10 may comprise a plurality of Goertzel filters 18a which may differ with respect to the frequencies that can be determined thereby.

Once the control unit 18 has determined the specified frequency 17 in the frequency portion 15, the control unit 18 can then generate and/or emit a control signal and/or switching signal, for example by means of a display element 23 of the user interface 20.

A computer program element, for example software instructions, may furthermore be stored in the memory 23, which instructions, when executed on the control unit 18, prompt the radar device 10 to analyse the receiving signal for the presence of the specified frequency 17.

In principle, the radar device 10 can be used for monitoring the object 12 at the specific distance 13 and it is possible to determine whether or not the object 12 is present. Alternatively or in addition, the radar device 10 may be used for monitoring a gap between the radar device 10 and a fixed, reflecting object, such as a wall. It is thus possible to check whether or not the gap is clear.

FIG. 2A shows a radar device 10 according to an embodiment of the disclosure. Unless otherwise described, the radar device 10 of FIG. 2A comprises the same elements and features as the radar device 10 of FIG. 1. FIG. 2B shows a (hypothetical) echo curve 30 determined using the radar device 10 of FIG. 2A, which curve represents the intensity of the receiving signal as a function of the distance and/or the frequency.

In the example shown in FIGS. 2A and 2B, an interfering object 25 is located between the object 12 or the object 12 to be identified and the radar device 10. In addition to the reflection on the object 12 to be identified, the transmission signal is also reflected on the interfering object 25 at least in part. The reflection on the interfering object 25 therefore results in an interfering reflection 27 in the echo curve 30.

In order to quickly determine the presence of the object 12, the radar device 10 is configured to determine the partial echo curve 19 merely and/or exclusively in the frequency portion 15 in which the specified frequency 15 associated with the object 12 is contained, as described above with respect to FIG. 1. All other frequency portions of the receiving signal can be dismissed by the control unit 18. The overall echo curve 30 shown in FIG. 2B therefore shows an echo curve 30 determined only hypothetically by the radar device 10.

FIG. 3 is a flow diagram for illustrating steps of a method for identifying an object 12 using a radar device 10 according to an embodiment of the disclosure. The method may denote a method for operating the radar device 10.

In a first step S1, a transmission signal is transmitted and a reflected signal is received by means of an antenna 14 of the radar device 10. In a further step S2, a receiving signal is generated by means of an evaluation circuit 16 of the radar device 10, on the basis of the reflected signal. In a further step S3, a frequency portion 15 of the receiving signal is evaluated by means of a control unit 18 of the radar device 10. In a further step S4, the presence of a specified frequency 17 in the frequency portion 15 is determined, which frequency corresponds to and/or is associated with a distance 13 of an object 12 from the radar device 10.

In addition, it should be noted that “comprising” does not exclude any other elements or steps, and “a” or “one” does not exclude a plurality. It is furthermore noted that features or steps that have been described with reference to one of the above embodiments can also be used in combination with other features or steps of other embodiments described above. Reference signs in the claims are not to be considered limiting.

1. A radar device for identifying an object, the radar device comprising:
at least one antenna configured to transmit a transmission signal and to receive a reflected signal;
an evaluation circuit configured to determine a receiving signal based on the reflected signal; and
a control unit configured to evaluate the receiving signal in a frequency portion of the receiving signal, and to determine whether a specified frequency that corresponds to a specific distance of the object from the radar device is contained in the frequency portion of the receiving signal.

2. The radar device according to claim 1,
wherein the radar device is configured as a Frequency Modulated Continuous Wave (FMCW) radar device, and/or
wherein the receiving signal is an FMCW receiving signal.

3. The radar device according claim 1,
wherein the radar device is configured as a limit level radar device for limit level monitoring of a medium in a container, and/or
wherein the object is a limit level of the medium.

4. The radar device according to claim 1,
wherein the object is a container and/or a reflecting object, in particular on a conveyor belt.

5. The radar device according to claim 1,
wherein the object is disposed on a conveyor belt.

6. The radar device according to claim 1,
wherein the control unit is further configured to evaluate the receiving signal in the frequency portion based on a Fourier transform, and/or
wherein the control unit is further configured to determine a partial echo curve in the frequency portion of the receiving signal, the partial echo curve being associated with a distance range from the radar device.

7. The radar device according to claim 1,
wherein the control unit is further configured to evaluate the receiving signal in the frequency portion based on a Goertzel filter, and/or
wherein the control unit is further configured to determine a presence of the specified frequency in the receiving signal using the Goertzel filter.

8. The radar device according to claim 1,
wherein the control unit is further configured to dismiss and/or to hide all frequencies of the receiving signal outside the frequency portion.

9. The radar device according to claim 1,
wherein the control unit is further configured to evaluate the receiving signal in a plurality of frequency portions and to determine whether the specified frequency is contained in respective frequency portions of the plurality of frequency portions.

10. The radar device according to claim 1,
wherein the control unit is further configured to examine the receiving signal exclusively for a presence of a single specified frequency.

11. The radar device according to claim 1, further comprising:
a user interface configured for user input relating to the specific distance of the object and/or to the specified frequency, and/or
wherein the control unit is further configured to determine the specified frequency based on user input relating to the specific distance of the object.

12. The radar device according to claim 1,
wherein the control unit is further configured to emit a control signal when the receiving signal contains the specified frequency.

13. A method for identifying an object using a radar device, the method comprising:
transmitting a transmission signal and receiving a reflected signal by means of an antenna of the radar device;
generating, by means of an evaluation circuit of the radar device, a receiving signal, based on the reflected signal; and
evaluating, by means of a control unit of the radar device, a frequency portion of the receiving signal while determining a presence, in the frequency portion, of a specified frequency that corresponds to a specific distance of the object from the radar device.

14. A nontransitory computer-readable storage medium having a program stored therein, which, when executed on a control unit of a radar device, prompts the radar device to perform a method according to claim 13.
